(19) United States
(12) Patent Application Publication
(10) Pub. No.: US 2007/0260506 A1
(43) Pub. Date: Nov. 8, 2007

(54) Team-Based Results-Focused Flexible Work Arrangements

(75) Inventors: Beatrice A. Fitzpatrick, New York, NY (US); Harvey A. Thomson, Fergus (CA)

Correspondence Address: PROSKAUER ROSE LLP, ONE INTERNATIONAL PLACE, BOSTON, MA, 02110, US

(73) Assignee: The Bold Initiative, New York, NY (US)

(21) Appl. No.: 11/745,655

(22) Filed: May 8, 2007

Related U.S. Application Data
(60) Provisional application No. 60/798,513, filed on May 8, 2006.

(51) Int. Cl. G06F 11/34

(52) U.S. Cl. 705/11

(57) ABSTRACT

A method for enhancing business results while simultaneously improving workplace flexibility for employees. Both objectives are achieved by continuously monitoring business parameters and modifying work processes using results-focused techniques, while concurrently using the same techniques to tailor workplace flexibility needs to ever-changing work and personal environments. Use of the method results in the synergistic accomplishment of workplace productivity and efficiency objectives, along with enhanced employee morale, retention, and job satisfaction, as well as work team cohesion, effectiveness, and engagement. The skills learned can then be used in other endeavors, such as for personal development, family management, and community leadership.

### CROSS REFERENCE TO RELATED APPLICATIONS

This application claims priority to and benefit of U.S. provisional application 60/798,513, filed on May 8, 2006, the contents of which are hereby incorporated herein by reference in their entirety.

### FIELD OF THE INVENTION

The invention relates generally to business methods for implementing flexible work arrangements, while simultaneously achieving increased business efficiency and/or productivity. More specifically, the application of results-focused management principles in combination with the proper application of specific workplace flexibility techniques synergistically produces unexpected business efficiencies and productivities, while simultaneously improving employee satisfaction and morale in a corporate environment.

### BACKGROUND OF THE INVENTION

Corporations around the world are continuously striving to reduce costs, and to improve productivity and efficiencies. Some have commented that in some industries maximum efficiencies have been achieved, and that only small, marginal improvements will be available in the future.

On another front, attempts to promote workplace flexibility in the workplace have met with mixed results. Previous programs have utilized department approaches in which flexible work arrangements were imposed on the department by management using a one-size-fits-all methodology. After implementation, business needs and situations would change, resulting in reduced effectiveness and often, in abandonment of the program.

Business consultants are often used to implement such programs, and must often be retained, each time a workplace flexibility program is to be “successfully” implemented or reinstated. Known programs are known to focus on coverage hours and general department resource scheduling. Moreover, as in many business programs, known workplace flexibility programs are implemented on a program-by-program basis in hopes that business efficiencies, productivity enhancements, and quality improvements will follow.

Unfortunately, there are drawbacks associated with these approaches. Workplace flexibility options are not fully effective for employees when implemented on a department-wide basis. Moreover, business and employee needs are dynamic, so any flexibility option developed for a department rapidly becomes outdated.

What is needed is a results-focused business work process that continually adjusts to meet ever-changing business and personal needs.

### SUMMARY OF THE INVENTION

Further corporate performance and efficiency improvements can be obtained by synergistically combining corporate change management principles with particular inventive workplace flexibility implementation and management techniques, such as in a corporate environment. Employee lifestyle and other benefits also result. These and other problems can be solved by the invention, which in one aspect features a method of using workplace flexibility to increase business productivity of an organization, which can include the steps of engaging team members of a working group, with management approval, soliciting input from the working group to improve a particularized team work process, and establishing goals in connection with the particularized team work process to be improved. The working group can be from a particular job function or organizational department, and can vary in size for different implementations. In some embodiments the working group has six members; in others it has 35. The particularized work process should be related to activities the working group shares and upon which they can have an impact. The goals should be related to the work process of the working group.

The method also includes measuring a performance of the improved work process over a predetermined period of time, preferably based on a previously-determined baseline measurement, and improving the performance of measured work process performance. The measurable improvement of the work process is enabled, at least partially, by incorporating individualized flexibility arrangements of the team members into the working process. The individualized flexibility arrangements should be memorialized within a formal schedule, on a regular basis. Preferably, the formalized memorialization of the individualized work schedule occurs weekly, although other time intervals such as semi-weekly, bi-weekly, and monthly can also be used. The formalized schedule should be incorporated into work methods of the work process, thereby enabling achievement of the goals of the particular team work process that is being improved.

The method can also include the step of customizing the implementation based on both the needs of the team members for flexibility and work requirements of the work process. Regularly scheduled evaluation and coordination of these objectives and requirements enables the synergistic benefits of the invention to be maximized. In some embodiments, the working group is established primarily or solely for purposes of implementing this process. In a preferred embodiment of the invention, management approval for implementation of the process mandatory.

The incorporating step of the process can also include individualized flexible work schedules for all or substantially all of the team or working group members, goals for improving individual and team performance, which team members have formulated and to which they are committed, and team-member initiated work process changes that enable achievement of the performance and flexibility goals. An implementation and review schedule for use in making adjustments to, e.g., the individualized flexible work schedules and/or the previously established goals, as conditions change, can also be used.

The method can also include assessing, as a team, performance results and the effectiveness of the individualized flexible arrangements of the team members, and using the assessment of flexibility and the work process performance measurement to improve an overall performance of the team members and the particularized team work process. The steps identified above can be repeated on a regular or predetermined basis to enhance efficiency and productivity of the work process, and/or to enhance the effectiveness of the individualized flexible work schedules, both from a business-needs perspective and from a personal or team perspective of the working group or team members. They can be repeated in the order indicated, although the precise ordering need not always be the same. In some embodiments, ordering of the steps needs to be changed, based on the situation to which the invention is being applied, in order to maximize effectiveness. Some embodiments include repeating steps, while in other situations it is acceptable to skip some of the steps.

The method can also include using a consonance of interests of the team members to help the team members meet their flexibility objectives while simultaneously improving work process performance. The individualized flexibility arrangements can be used to enable employees to gain greater control over their lives at both work and home, to enable achievement of many of the goals and objectives described herein. Utilization of the individualized flexibility arrangements can result in enhancement of individual team member satisfaction, individual team member engagement for purposes of attracting and retaining employees, and/or reducing absenteeism.

The incorporating step can also include using the individualized flexibility arrangements of the team members to change the nature of relationships between the team members to enhance one or more of collaboration, cooperation, mutual support, and functional/job redundancy (such as cross training), thereby enriching a value of the team members to the organization and to each other. Absenteeism can be (and generally is) reduced and team member retention can be increased by the incorporation of the individualized flexibility arrangements. Additionally, the change in the nature of relationships between the team members facilitates mediation of conflicts within the workgroup on a periodic basis.

The method can also include applying the process to an increased number of working groups, thereby increasing the scope of the application and the magnitude of the benefits to be achieved. Facilitators can be trained to implement the process on a larger scale of the organization, e.g., throughout a larger portion or the entirety of a business enterprise. Embodiments also include establishing a program management office to oversee a strategy for, e.g., an enterprise-wide scale up of workplace flexibility. The program management can include one or more of identifying and training facilitators, tracking an impact of the method on one or more of performance, retention, absenteeism, employee satisfaction, and communicating results of the method, e.g., to management, media organizations, and the like.

Another aspect of the method comprises using workplace flexibility to increase business productivity of an organization, including the steps of engaging team members of a working group, with management approval, soliciting input from the working group to improve a particularized team work process, and establishing goals in connection with the particularized team work process to be improved. The working group can be from a particular job function or organizational department, and can vary in size for different implementations. In some embodiments the working group has only a few members; in others it can have several dozen. The particularized work process should be related to activities the working group shares and upon which they can have an impact. The goals should be related to the work process of the working group.

The method also includes measuring a performance of the improved work process over a predetermined period of time, preferably based on a previously-determined baseline measurement, and improving the performance of measured work process performance. The measurable improvement of the work process is enabled, at least partially, by incorporating individualized flexibility arrangements of the team members into the working process. The individualized flexibility arrangements should be memorialized within a formal schedule, on a regular basis. Preferably, the method includes a scheduling means that includes formalized memorialization of the individualized work schedule that occurs weekly, although other time intervals such as semi-weekly, bi-weekly, and monthly can also be used. The formalized schedule should be incorporated into work methods of the work process, thereby enabling achievement of the goals of the particularized team work process that is being improved.

The incorporating step of the process can also include individualized flexible work schedules for all or substantially all of the team or working group members, team-determined and management approved goals for improving individual and team performance, to which the team members are committed, and team-member initiated work process changes that enable achievement of the performance and flexibility goals. An implementation and review schedule for use in making adjustments to, e.g., the individualized flexible work schedules and/or the previously established goals, as conditions change, can also be used.

### BRIEF DESCRIPTION OF THE DRAWINGS

The foregoing discussion will be understood more readily from the following detailed description of the invention, when taken in conjunction with the accompanying drawings, in which:

FIG. 1 illustrates a known method of implementing an individualized modification of working arrangements for an employee;

FIG. 2 illustrates another known method of implementing work arrangement flexibility options, in which a standard set of arrangements are offered by the employer to a group of employees, in a one-size fits all configuration;

FIG. 3 illustrates an embodiment of three Stages involved in implementing a team-based results-focused workplace flexibility method, according to an embodiment of the invention;

FIG. 4 illustrates the Tasks within each Stage that can be used to implement an embodiment of a continuously modified, team-based, results-focused workplace flexibility option, according to an embodiment of the invention;

FIG. 5 illustrates Steps that can be associated with the first Stage (100) of an implementation of the method;

FIG. 6 illustrates Steps that can be associated with the second Stage (200) in an implementation of the method;

FIG. 7 illustrates Steps that can be associated with the third Stage (300) in an implementation of the method;

FIG. 8 illustrates a management guidance tool that can be used, in the first Stage of the process of establishing a flexible workplace;

FIGS. 9A and 9B illustrate a tool that can be used to assist a project team in developing a workplace flexibility plan; and

FIG. 10 illustrates a tool that can be used to track the performance of a project team in implementing changes in work processes.

### DETAILED DESCRIPTION

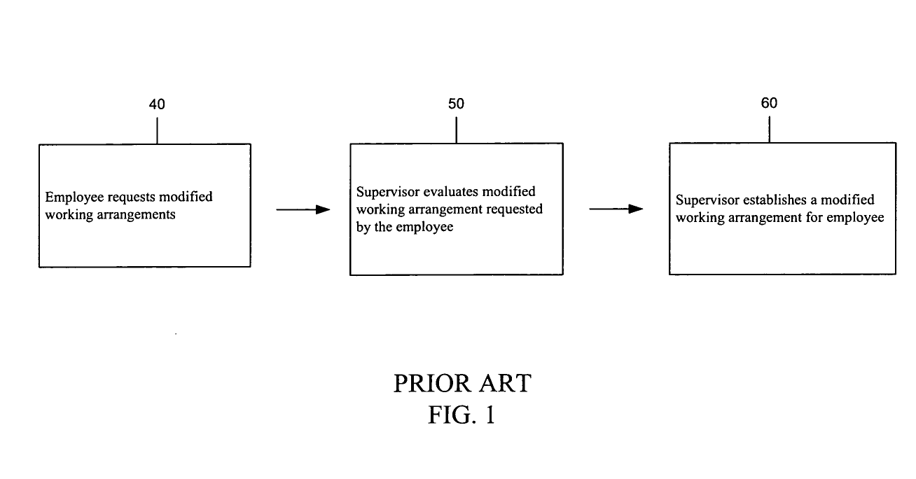

Employees desire flexibility in work schedules to accommodate other, e.g., non-work, aspects of daily life such as family, education and other types of responsibilities. In the past, a company will often use a standard method of implementing flexible work arrangements for employees on an individual basis. Referring now to FIG. 1, there is shown a known method of implementing an individualized modification of working arrangements for an employee. This is accomplished in step 40, when an employee requests a modified working arrangement. As indicated in step 50, a supervisor evaluates the proposed working arrangement and determines its practicability. Once a supervisor approves a new working arrangement, 60, the process ends and the employee is again locked-in to a fixed work schedule.

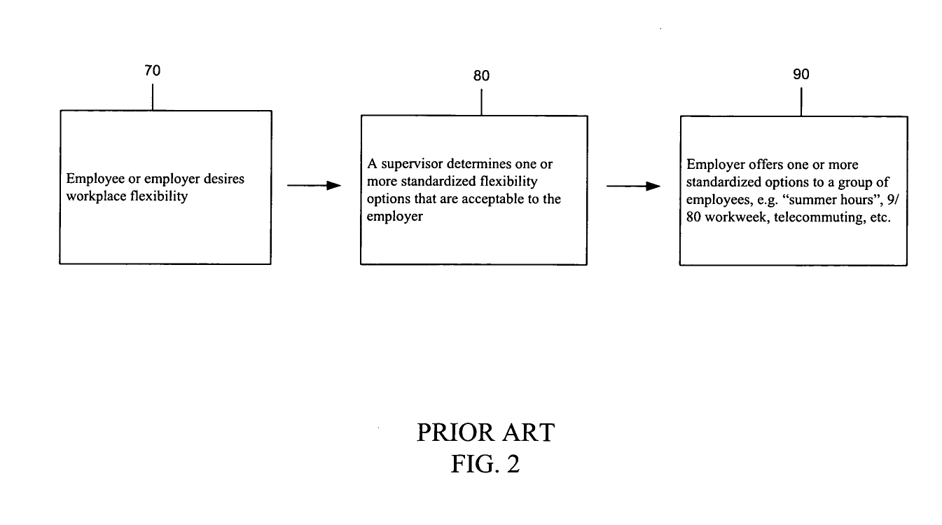

Another known method of implementing flexible work arrangements for employees is illustrated in FIG. 2. This method is used when an employee or employer desires workplace flexibility, 70. An employer can offer work arrangement flexibility to attract and retain employees. An employee can desire flexibility in their work schedule to accommodate other areas of daily life such as family, education and other responsibilities. However, often workloads vary for different work teams from the beginning to the end of the week, or in monthly or seasonal cycles. When employees are on a fixed weekly schedule, these companies are required to staff up closer to what is needed for the peak periods or, more typically, pay overtime for staff to work longer on certain days. A supervisor can identify one or more standardized flexibility options, 80, that are acceptable to the employer. A company or department then offers one or more standardized working arrangement options to a group of employees, 90, such as a “summer hours” work schedule, 9/80 work weeks (working 80 hours over two weeks, but using only 9 business days), telecommuting, and the like. The work group is restricted in this approach because only a limited number of working arrangement options are offered (often only one alternative), and the option is offered only to the group as a whole. Consideration of the specific needs of only one individual is not a part of the determination. In this method an employee is not offered individualized flexibility. Once a new set of working arrangements is implemented, the process ends and the group of employees is again locked into a fixed work schedule.

Key company objectives include remaining competitive while attracting and retaining valued employees. Economic, demographic and sociological trends increasingly are adding to the misalignment between work and family demands for employees. Family structures have changed dramatically, making it increasingly difficult for employees to meet family as well as work obligations. Also, competitive pressures are causing companies to drive down costs by outsourcing work or reducing staff, putting an even greater burden on those who remain employed. By implementing flexible work schedules, a company can be in a better position to attract and retain employees.

However, when the focus of increasing workplace flexibility is on employee well being, what is often overlooked is that companies have an equally compelling, but often unrealized, need for flexible work arrangements. This shared need for flexibility provides the common ground on which both a company and its employees can pursue the goal of creating a much more flexible, dynamic and proactive workplace for a mutual benefit. But the implementation of corporate change management technology, using team-based results-focused business work processes in combination with individualized implementations of workplace flexibility, in combination with a formalized, memorialized work schedule, is required to most effectively achieve these shared goals.

A team-based results-focused approach to the introduction of flexible work arrangements capitalizes on the shared need of both companies and their employees for increased flexibility. By inviting a work team to set performance improvement goals, identify their personal needs for flexibility, devise innovative work schedules to meet these needs, and explore ways to improve the work process, both improved performance and increased flexibility is accomplished. A company can be able to measurably enhance individual and work group performance, while, at the same time, expand the range and utilization of flexible work options to relieve employee stress. A company can address significant business challenges and enhance performance by implementing flexible work arrangements as the primary improvement strategy. This can be achieved by implementing team-based results-focused workplace flexibility. Along with increased flexibility, measurable gains in performance can be achieved.

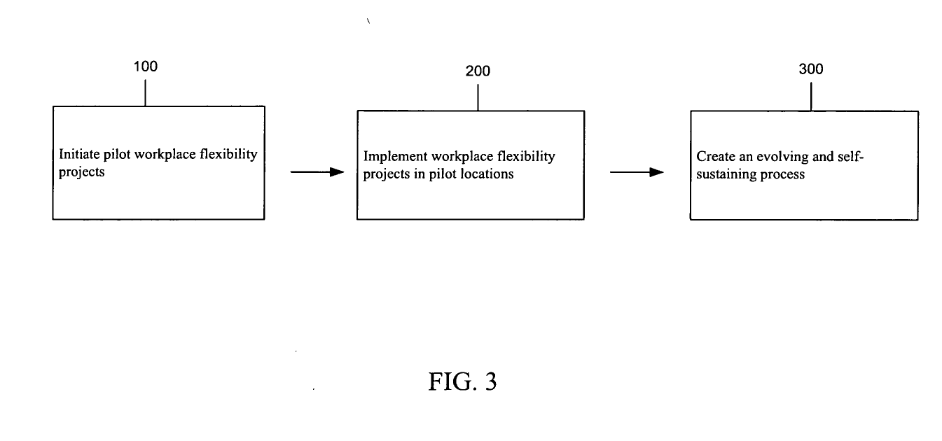

FIG. 3 illustrates an embodiment of the invention that utilizes three Stages for implementing a team-based results-focused workplace flexibility option. This approach can be used to create a win-win situation for a company and its employees. By allowing teams to determine, with management approval, and implement individualized flexible work schedules for each member of the team, they can be more engaged in accomplishing organization goals. In the first stage, 100, the implementation of team-based results-focused workplace flexibility projects is initiated. In a pilot location a new workplace flexibility approach can be guided by a design team. A pilot team creates and tests, 200, a scheduling option that makes it easier for team members to meet personal demands. The pilot team can simultaneously, by adopting innovations in work methods that it has identified, enhance performance and/or productivity. Changes in the work processes used by a team, such as how a work process can be streamlined, can be introduced incrementally and can be implemented to support a specific performance improvement goal set by a team.

The pilot projects demonstrate the power of a team-based, results-focused approach to workplace flexibility and offer insights regarding what is required to apply this approach on a larger scale. The modest scale of the pilot project permits experimentation so that the approach can be modified to address unanticipated consequences of the original plan for a given work group. Based on the results achieved and the information gathered in the short-term pilot projects, a company can create an evolving and sustaining process to implement a workplace flexibility plan, which is team-based and results-focused, throughout the company, 300. The process can also be spread to other companies, locations, and/or work sites.

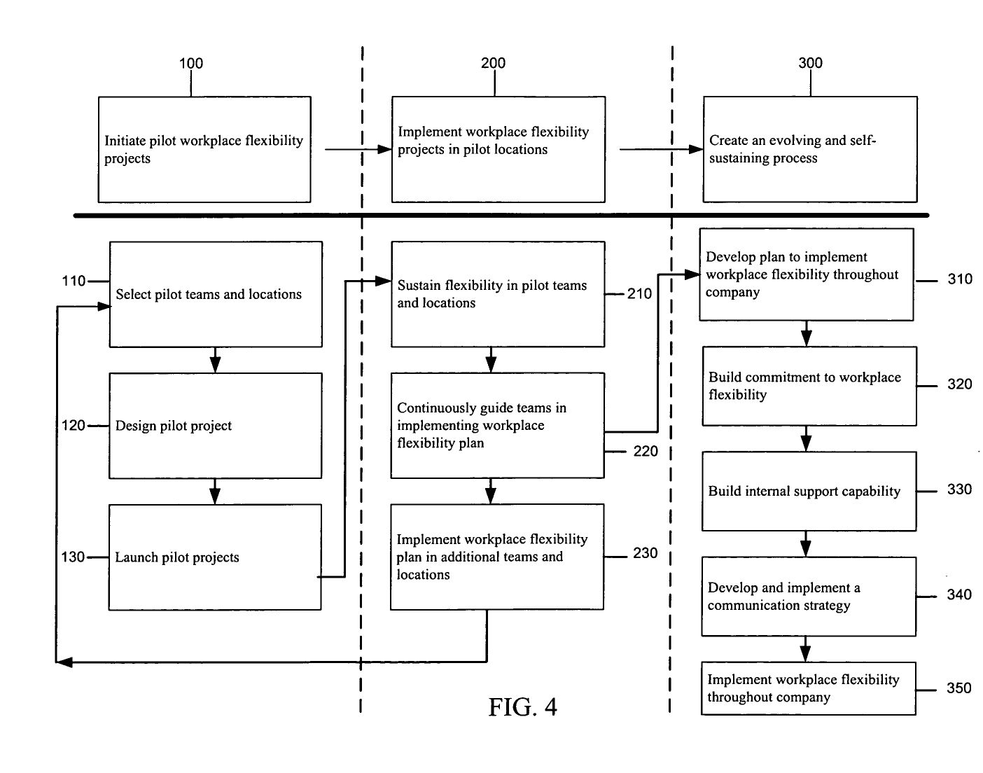

FIG. 4 illustrates Tasks (110, 120, 130, 210, 220, 230, 310, 320, 330, 340, and 350) that can be used within each Stage for implementation of a continuously modified results-focused workplace flexibility program, according to an embodiment of the invention. During Stage 100 companies, typically, will pilot the approach in one or several locations or functions within a business unit, 110. A design team 120 can determine which teams will participate in the pilot project, identify the key performance measures for which the team will need to set improvement goals, and identify some of the ground rules that the teams will need to follow in developing their flexibility schedules. Next, the pilot projects can be launched 130.

Moving to Stage 200, the workplace flexibility projects are implemented in the pre-selected pilot teams and locations by introducing flexible work arrangements to the entire work team on an individualized basis. The flexibility plan is sustained in the pilot teams and locations, 210, by monitoring the progress of the implementation process. The teams are continuously guided by the design team 220. The workplace flexibility plan can also be implemented in additional teams and locations 230.

In the third Stage 300, an evolving and self-sustaining process of implementing workplace flexibility is created. A company wide plan can be developed to adopt workplace flexibility 310, and a commitment to workplace flexibility can be built 320, utilizing internal support capabilities 330 that have been established. A communication strategy is developed and implemented 340 to ensure success of the results-focused workplace flexibility program. Finally, the plan can be implemented company-wide 350.

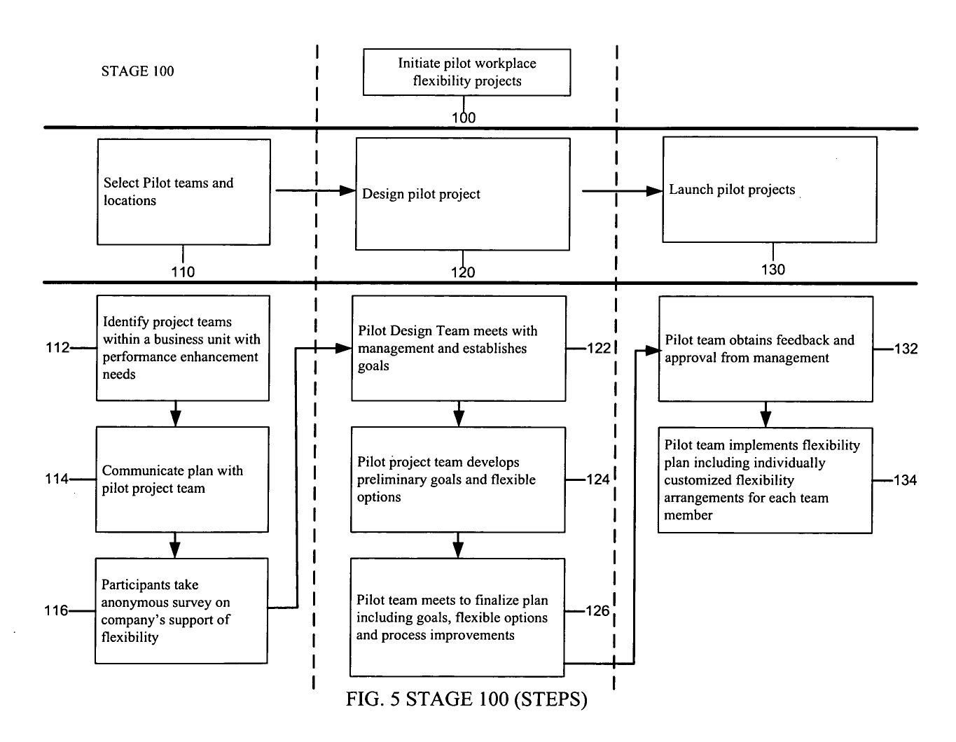

FIG. 5 illustrates detailed Steps that can be associated with Stage 100 of an implementation of the method. In the task of selecting pilot teams and locations (110), a unit can be identified in which there is a compelling business reason for improving performance and increasing flexibility 112. A senior management team willing to experiment with innovative approaches to work schedules and work methods is helpful, but not mandatory, and can be used. Participating managers can meet with pilot teams to enlist their participation in creating a more flexible and productive workplace. A business unit can test out the team-based, results-focused approach to flexibility with one or several pilot teams. The opportunity to implement workplace flexibility by combining performance goal setting with individual flexible work schedules is communicated to the pilot team 114. In some embodiments, participants can take an anonymous survey measuring the company's support of flexibility in their individual work schedules 116.

The implementation of workplace flexibility is then designed by the design team (task 120). The pilot design teams are selected to meet with management and are requested to establish suggested goals for enhancing performance, thereby increasing competitiveness of the company in the market place 122. The pilot team collects baseline information of a work team's performance and on the existing standard flexibility arrangements, if it is available. Otherwise, the baseline information should be collected. Preliminary goals and individualized flexible work schedule options are identified by the pilot team 124. After initial measurable goals are determined by the pilot teams and approved by management, team members can be invited to use their creativity and experience to come up with a plan for making the team more productive and eliminating unnecessary work. The pilot teams can then meet to decide what work process changes need to be implemented to obtain the measurable goals needed to reflect increases in performance and productivity. At the same time the pilot teams determine the flexibility needs of the individual team members' in their work schedule. A staffing option and innovative work methods for meeting both performance improvement goal and team members' needs for flexibility is developed by the pilot team.

Opening up flexible options to all team members as a legitimate way to accomplish team goals removes the stigma attached with receiving special consideration and avoids putting the manager in the position of arbitrating between team members' competing needs for flexibility. All team members' individual needs for flexibility are considered equally valid and the pilot team itself determines what aggregate schedules will work best, therefore team members are more likely not to resent covering for someone else who has a schedule negotiated bilaterally with a manager. Therefore, the fact that team members can consider their own needs for flexibility in designing the optimal work arrangements only reinforces their commitment to successfully implement the plans they have developed. This approach explicitly links workplace flexibility with team performance. It enables both the company and the individual employees to be more effective and in greater control over their resources. In so doing, it strengthens the common ground between those who are striving to make their companies more competitive and those who are trying to cope with a growing disconnect between the way work is structured and what employees need in order to gain greater control over the multiple demands on their time. Employee engagement is the key to using flexible work arrangements as a strategy for creating effective workplaces.

A formal schedule is then memorialized, and reestablished periodically, to reflect the identified individual flexibility needs of each employee in conjunction with the performance and business needs of the company. This formal schedule can be revisited, e.g., weekly, to accommodate changes in individual team members' needs, as well as changes in the work requirements for the pilot team. By formalizing the schedule and memorializing it weekly, changes in employee and company needs can be recorded for future reference. A determination than can be made on a quarterly or seasonal basis of how needs change for both employees and the company. This can better utilize the synergistic effect workplace flexibility has on company productivity and employee retention and morale. The flexibility plan is then finalized by the pilot team 126. Finalization of the plan can comprise one or more of reaching team consensus on and commitment to the performance improvement goals, resolving any conflicts between the aggregate individual flexible schedules and the ability of the team to meet its performance improvement goals, brainstorming work process improvements, and developing procedures for maintaining up-to-date work schedules and ensuring the accessibility of team members to customers, managers and other parties while working on alternate work schedules.

The final task 130 of the first Stage 100 is launching of one or more pilot projects 130. The first step of this task is for management to approve the formalized work schedule and work process changes of the pilot team 132. The pilot teams can then implement their formalized work schedule and the results-focused work process changes that they have identified 134.

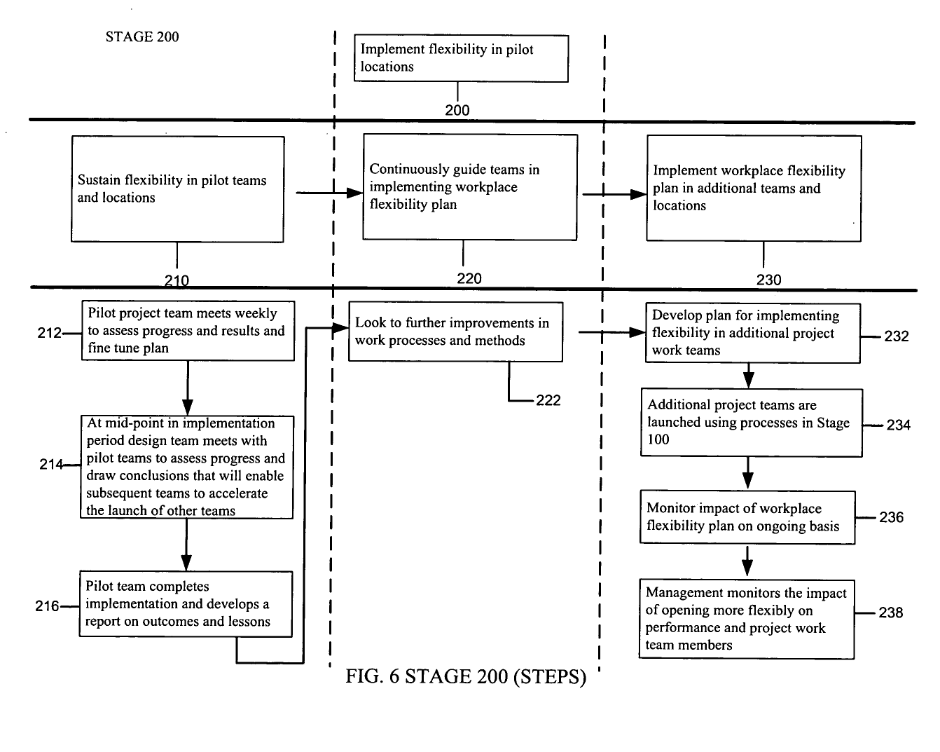

FIG. 6 illustrates detailed Steps (212, 214, 216, 222, 232, 234, 236, and 238) that can be associated with the tasks (210, 220, and 230) of the second Stage, 200. The flexibility plan is implemented in the pilot locations (Stage 200). Flexibility is sustained in the pilot teams and locations (task 210) by meeting, e.g., weekly, to assess progress and results, fine tuning the plan (210 and 212), including adjusting work schedules to accommodate changing business and personal needs. Preferably, the pilot teams meet weekly to assess progress and results while fine tuning the plan 212. At mid-point in the implementation process the design teams meet with the pilot teams to assess progress and draw conclusions that will enable subsequent teams to accelerate the company wide launch of other teams 214. The pilot teams can then complete the implementation and develop a report on outcomes and lessons identified in their implementation process 216.

In the next task, the pilot teams can be continuously guided in implementing workplace flexibility 220 by looking to implement further improvements in work processes and methods 222. Following, e.g., a 3-month implementation period, the pilot teams can set further improvement goals, identify further work process improvements, and continue to adjust their flexible schedules to accommodate changes in work demands, changing circumstances of team members, and changes in team composition.

In the third task of this second Stage, the workplace flexibility plan is then implemented in additional teams and locations 230. A plan can be developed for implementing flexibility in additional project work teams 232. Additional project teams are launched using the processes detailed in the first Stage (100), in step 234. The impact the workplace flexibility plan has on the company and its employees is monitored on an ongoing basis 236. Management also monitors the impact of operating more flexibly on performance and project work team members 238. As more pilot teams are implemented in the pilot locations, management develops the means for aggregating the overall impact on the location's performance and tracks changes in morale, employee satisfaction, turnover, and absenteeism.

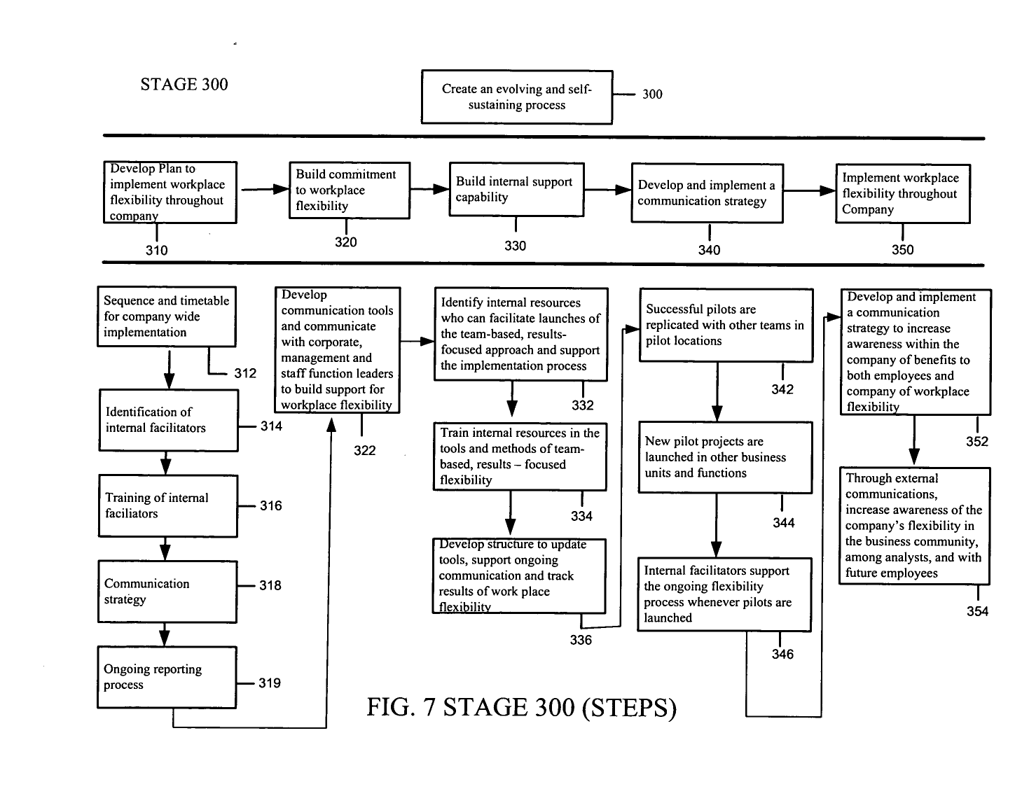

FIG. 7 illustrates detailed Steps (312, 314, 316, 318, 319, 322, 332, 334, 336, 342, 344, 346, 352, and 354) that can be associated with the third Stage (300) of an embodiment of the method, in which an evolving and self-sustaining process for implementing workplace flexibility throughout the company is created. This third Stage 300 can be accomplished utilizing the tasks of developing a plan to implement flexibility throughout the company 310, and building commitment to results-based workplace flexibility 320, company-wide. An internal support capability 330 can be built within the company, while a communication strategy is developed and implemented 340. Finally, the workplace flexibility plan is implemented throughout the company where practicable 350.

In the first task, developing a plan 310, of this third Stage 300, a sequence and timetable for company-wide implementation of the program can be created 312. The internal facilitators can be identified 314, after which they can be trained 316. The strategy is then communicated 318, and an ongoing reporting process can be used 319.

In the next task, building commitment 320, communication tools can be developed and communicated with corporate management and staff functions leaders, in order to build support for the results-focused workplace flexibility program 322. The task of building internal support capability 330 can be next, which can include steps of identifying internal resources who can facilitate subsequent launches of the program, and can support the process 332. Internal resources can be trained in use of tools and techniques described herein for implementing the process 334, and a structure can be developed to update these, support ongoing communication, and track the performance and flexibility results of the program 336.

Implementation of the communication strategy (task 340) can include the steps of replicating successful pilot programs with other teams in additional locations 342, and new pilot projects can be launched in other business units and functions 344. Internal facilitators should be used to support the ongoing results-based flexibility processes wherever pilots are launched 346.

Finally, workplace flexibility can be implemented throughout the company (task 350). A communication strategy can be implemented to increase awareness within the company of the benefits to both employees and the company of the workplace flexibility benefits of the invention, and their synergistic achievement of enhanced business productivity and efficiencies 352. External communications can also be used to increase awareness of the company's flexibility in the business community, among analysts, and with prospective employees 354.

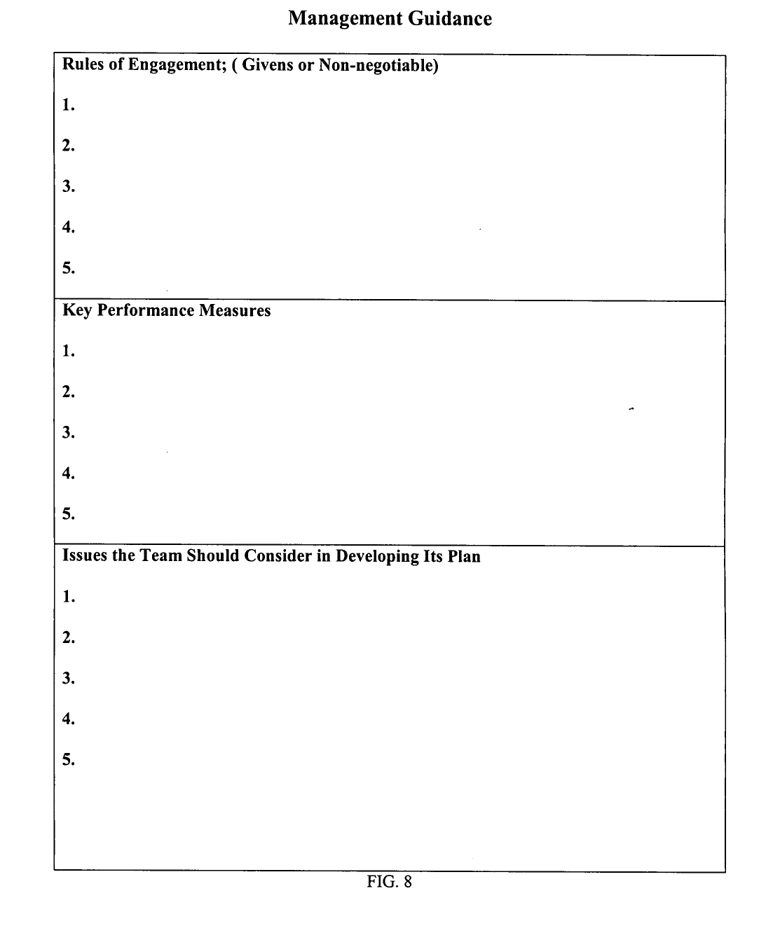

FIG. 8 illustrates a management guidance tool that can be used, e.g., in the first Stage of the process of establishing a team-based, results-focused workplace flexibility plan. This tool can be used, e.g., in the first Stage 100 illustrated in FIG. 5. The tool enables managers to provide guidance regarding, for example, business considerations that need to be respected in developing a team flexibility plan, and important performance measures regarding which the pilot team should set improvement objectives. The Management Guidance template can be completed by the design team in Step 122, and then can be introduced to the pilot team in Step 124.

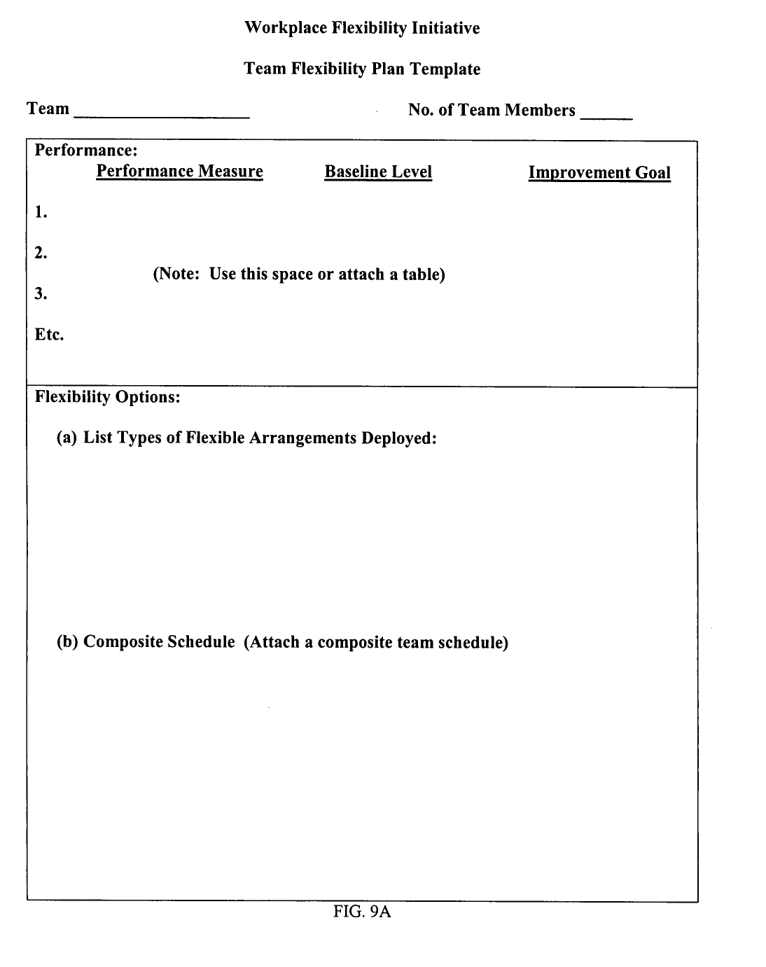

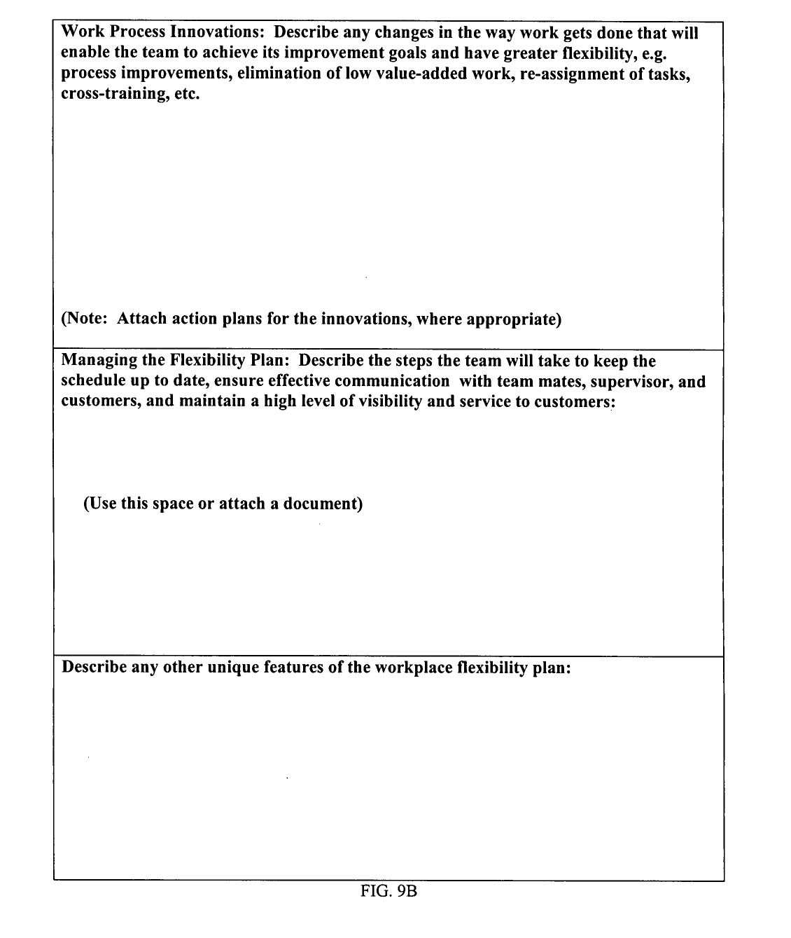

FIGS. 9A and 9B illustrate a tool that can be used to assist a project team in developing a workplace flexibility plan. This tool can be used, e.g., in the first Stage 100 illustrated in FIG. 5. This Team Flexibility Plan Template can be used to identify elements of the Team Flexibility Plan to be created by the pilot team for implementation 134, following approval by management. In Steps 124 and 126, the pilot team reaches agreement on the elements of the plan, e.g., performance measures and goals, team work schedule, work method improvements, and steps to manage through the implementation period the team's flexibility plan, which comprise the parts of the template. In preparation for Step 132, obtaining approval of the plan from management, the pilot team can complete the template.

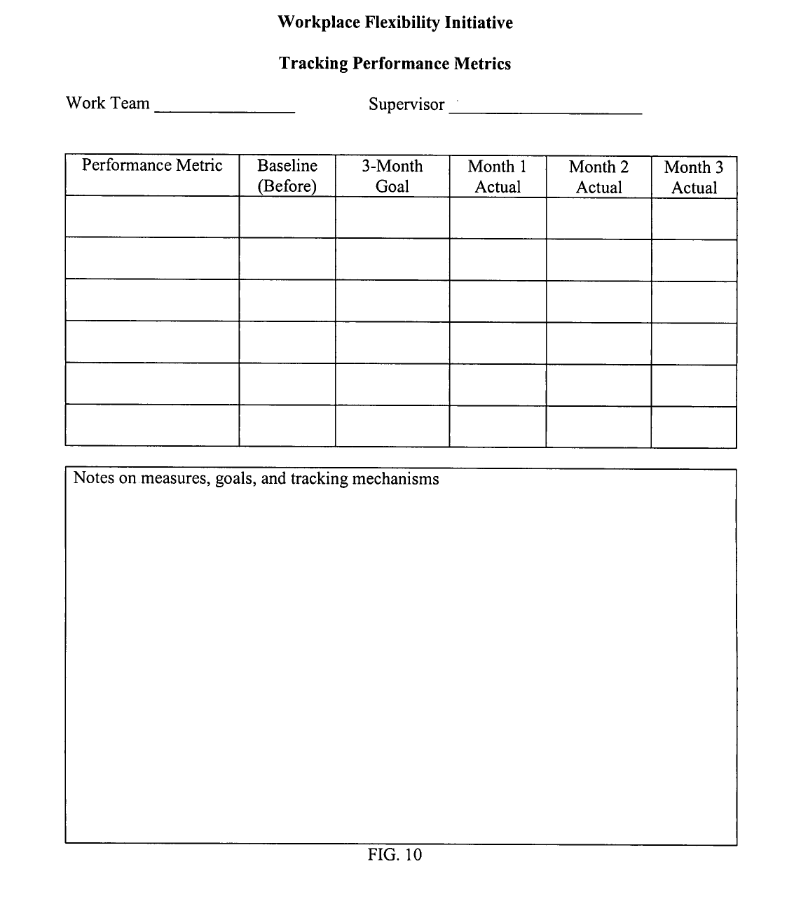

FIG. 10 illustrates a tool that can be used to track the performance of a project team in implementing changes in work processes. This Tracking Performance Metrics tool can be used in the first Stage 100 illustrated in FIG. 5. The tool helps the pilot team and its management to establish baseline performance information, to set, e.g., 3-month improvement goals, and to monitor performance against these goals on a regular, e.g., monthly basis. The pilot team can complete the first three columns of the plan, i.e., performance measure, baseline, and improvement goal in Step 126, and present it to management for approval in Step 132. During the implementation period in Step 214, the pilot team can review measured progress against the improvement goals established in Step 124.

The benefits of the processes described above can be better understood by considering the following examples. These examples also illustrate that the step sequencing can be varied to respond to changing circumstances and to accomplish the required objectives. In some situations and embodiments, not all steps of the method are required, and some steps can be repeated.

### EXAMPLE 1

### Transportation Company

At an international multibillion dollar U.S.-based transportation company, during development of the invention and using the techniques described herein, an Accounts Payable team reduced invoices in suspense (unresolved because of disputes with the providers) by over 60% and price changes in suspense by over 90%. The team also took care of a backlog of unclosed monthly balances, closing 6 backlogged months in the 90 day implementation period. The team was also able to discover an equipment code incorrectly priced for a recovery of over $500,000.

Another pilot team, Communications, surveyed their internal customers regarding the service they were providing while implementing their flexibility plan. Customers were asked whether service had improved or worsened on such dimensions as phone and email response time, quality of work, availability of support, time to resolution and quality of meetings. Depending on the item, improvement was noted by between 25 and 40% of 45 respondents. Of the 45, the rest viewed performance as the same as before, while no more than 3 of them reported a drop in performance (on one item—availability).

The team-based, results-focused approach to flexibility positively impacted employees as well. One employee reported that when her group was selected to participate in the workplace flexibility initiative, she was skeptical that a person in her position (administrative) would be able to participate given that her role is to support the management team. On a good day, she had a one hour commute each morning and a little longer in the evening. She has two children, an infant and a seven year old who is involved in sports.

She decided to try leaving work one hour early each day, and working from home one hour in the evenings. She is now home no later than 5:15 PM, and has ample time to feed the children, ensure that homework is completed, and attend baseball practice and games. By 9:00 PM, after her children are in bed, she returns to the computer to complete her work day. One of the best results for her is that she has her husband's complete support, and, while she's working from 9:00 to 10:00 PM, he cleans the kitchen, packs the baby's bag for the next day, and completes all their nightly chores.

This work arrangement has allowed her to plan and prioritize her day. Because she has a plan, she feels less stressed in the evenings, and at work. She feels she is a better wife and parent, and her self-confidence has soared.

Another working parent reports that, as a result of her new flexibility, her commitment to the company has been renewed; that she feels more empowered by the trust which her company has invested in her, and opines that this approach to flexibility is not only about enhancing performance. It is also about the company engaging individually with each employee to help them achieve the quality of life as well as work that a person needs.

The preceding example and employee comments illustrate how the invention allows both employee satisfaction and quality of life to be enhanced, while simultaneously achieving substantial performance and efficiency improvements for the company.

### EXAMPLE 2

### Media Organization

A leading, international, multibillion dollar media organization piloted team-based results-focused workplace flexibility in its newspaper properties, beginning with two newspapers in Nevada and Michigan. Work activities at the former focused on the pre-press operation, where the advertising graphics and news stories were compiled for the daily paper. In Michigan, management chose to focus on circulation, i.e., the delivery of both their daily paper and a series of community weeklies.

Performance gains were obtained in both locations. For example, in Michigan, where the focus was on the supervisors and district managers responsible for circulation, District Service Manager turnover was reduced by over one third, while carrier turnover was reduced by over 25%. Customer complaints were down and sales increased by 26% through the pilot period. In the pre-press operation in Nevada, significant process improvements were made by the teams, which shortened the creative cycle, while reducing overtime. Subsequent to the pilot project, the Nevada operations were able to restructure their pre-press operation, reducing an entire Saturday shift, reducing workloads and stress on employees, while retaining the staff.

In addition to these performance gains, employees were able to introduce greater flexibility into their schedules including working from home, working longer hours on some days and not working on other week days, varying their start and stop times, and modifying their lunch hours. Each team member was able to develop the schedule that worked best for him or her as long as that schedule enabled the employee to contribute fully to the ability of the pilot team to achieve its business goals

### EXAMPLE 3

### Property and Casualty Insurance Company

A premier international, multibillion dollar property and casualty insurance company applied team-based results-focused workplace flexibility in its claims organization. The following information details an implementation of an embodiment of the invention at this facility. The step numbers cited below correspond to those in the preceding figures and description.

Major Field Office of a Claims Processing Unit
Step 110: Select pilot teams and locations.
The corporate Human Resources Function and the head of the claims Operation determined that the claims function was a desirable place to introduce flexible work arrangements because of the desire to attract and retain talent, and to avoid the costs of turnover. They selected one major field office to start, based on the openness of the Director to new approaches to flexibility
Step 120: Design pilot projects.
The Director created a design team comprised of himself, the local Human Resources representative, and two supervisors. The design team, assisted by a consultant [Applicants], (a) determined which teams would participate in the pilot project, identified the key performance measures for which the teams would need to set improvement goals, and identified some of the ground rules that the teams needed to follow to develop their flexibility schedules, e.g. customer service comes first, minimum coverage during “core” work hours, etc.
Step 130: Launch pilot teams.
A Human Resources (HR) staff person facilitated a 2-hour launch meeting with each pilot team. At the meeting: (a) The Director communicated the importance of flexible arrangements to the company and the need for flexibility to benefit both employees and the company; (b) The HR staff oriented the team to Applicants' approach to workplace flexibility; (c) the Director communicated the key performance areas and the ground rules for flexibility; (d) team members discussed possible performance goals and information that needed to be gathered following the meeting; (e) team members discussed the range of flexible arrangements to be considered.
Team members took on assignments following the launch meeting (a) establishing the baseline performance on the key measures and establishing provisional 3-month improvement goals; (b) individual team members each created a weekly or bi-weekly work schedule best suited to his/her own needs, consistent with getting the work done; (c) The team aggregated the individual schedule preferences into a team schedule and identified any issues that might arise in terms of the team's ability to work together to achieve the performance goals of the team.
At a 2-hour follow up meeting, facilitated by HR, the team: (a) reached agreement on the performance improvement goals; (b) worked out any issues in the team flexibility schedule and finalized the schedule; (c) Identified work process improvements that it would undertake to achieve both greater flexibility and the improvement goals, and (d) agreed on the steps to be taken to manage the plan—how to communicate the team schedule, how and how often to update the schedule, how to handle messaging, telecommuting, etc., and how and when progress on achieving performance goals would be reviewed.
At the end of the second meeting, or in a subsequent meeting, the team presented its flexibility plan to management and sought approval. The plan included (a) 3-month performance improvement goals; (b) the team schedule for flexible arrangements; (c) process innovations, and (d) a plan for managing the flexibility.
In the claims function, performance improvement goals included:

TABLE 1

| Performance Area | Baseline | Goal |
|---|---|---|
| Loss Time Benefit Timeliness | 90% | 92.5% |
| 24 hour contact timeliness (insured) | 79% | 84.0% |
| Reduce escalation calls | 10-12/month | Reduce by 1-2 |
| Expense payments | 24-48 hours | Reduce by 50% |

Step 134: Implement workplace flexibility plan in pilot teams and locations.
At an agreed upon date, the team implements its flexible schedule and process improvements. The team meets briefly weekly or bi-weekly to discuss how the plan is working and makes adjustments to the plan—schedules and/or work methods—to ensure that it is serving the needs of both the company and the team members. Each month the team meets formally with management in the claims function to review progress against the performance improvement goals and to discuss how the plan is working both for the company and team members.
At the end of the 3-month pilot, management and the team meet to assess the results—both quantitative and anecdotal evidence. In the case of the claims teams in the field office, performance improvements were realized in 14 of the 16 measures. Sample results included:

TABLE 2

| Performance Area | Baseline | Goal | Results |
|---|---|---|---|
| Loss Time Benefit Timeliness | 90% | 92.5% | 100% |
| 24 hour contact timeliness | 79% | 84.0% | 89% |
| (insured) | | | |
| Reduce escalation calls | 10-12/mo. | Reduce by 1-2 | 5/mo. |
| Expense payments | 24-48 hrs. | Reduce by 50% | 24 hrs. |

Pilot team members' perceptions of the company's support for flexibility also improved significantly. On a survey, the following percentage of team members agreed or strongly agreed with the following statements:

TABLE 3

| Statement | Before | After |
|---|---|---|
| Flexible options are seen as an essential | 35% | 60% |
| strategy for responding to our customers | | |
| Our top managers promote flexible | 47% | 66% |
| work options | | |
| Those on flexibility are equally likely | 50% | 80% |
| to receive positive performance | | |
| assessments as others | | |
| Co-workers are usually supportive of | 35% | 64% |
| employees who use flexible work | | |
| schedules. | | |

Team members also reported improved teamwork, greater satisfaction with their roles as parents and spouses, as well as increased confidence at work.
Step 210: Sustain flexibility in pilot teams and locations
At the end of 90 days, the pilot teams discussed and committed to further improvements in performance and also considered other work method improvements and continued to operate flexibly. Additional teams were selected and followed the process outlined in Steps 160 and 170 above.
Step 230: Implement workplace flexibility in additional teams and locations
Other claims offices were identified to participate and the Steps 112, 114, 116, 122, 124, 126, 132, and 134 were followed with work teams in these offices as well.
Step 220: Continuously guide teams in implementing workplace flexibility plans.
Local HR staff and managers who have already used Applicants' approach acted as coaches to managers and supervisors who were just starting to implement the approach.
Step 350: Develop a plan to implement workplace flexibility throughout the company
Functional Directors, Human Resources staff, and the Corporate Champion for workplace flexibility met to develop a plan for implementing workplace flexibility throughout the company. At the meeting, this group (a) assessed the results of the pilot applications both on team performance and on team members; (b) drew learnings and implications from the pilot projects, and developed an implementation strategy including: implementation schedule, communication strategy, identification of internal resources to facilitate implementation, training plans, and a process for tracking the impact of flexibility across the organization.
Step 320: Build commitment to workplace flexibility
The Corporate Champion for workplace flexibility presented to senior management the results of the pilot implementations, the benefits to the company and to the participating employees, and the strategy for implementing flexibility across the company.
Step 330: Build internal support capability
The Corporate Champion identified internal staff—Human Resource staff, key line managers—and provided a training program to teach them how to design workplace flexibility pilot projects and to facilitate the launch meetings with pilot teams.
Step 340: Develop and implement a communication strategy.
Through the use of internal newsletters, videos, and other presentation media, communicated about the importance of workplace flexibility and presented case studies of successful implementations. Through publication in external media, communicated to the business community and to prospective employees the company's commitment to flexibility.
Step 350: Implement workplace flexibility throughout the company
Created a program management office to support the implementation of workplace flexibility throughout the company. Responsibilities of the office included (a) tracking the progress of implementation and its impact and reporting periodically to senior management (b) expanding the pool of qualified internal resources to facilitate implementation (c) implementing the communication strategy.

At the Workers' Compensation line of the Chicago office of this same company, two teams of claims adjusters were able to reduce escalations (service complaints) by over 50%, Loss Services payment of expenses turn around time was reduced by 50%, and unscheduled time off decreased 54%.

Many employees at this company, like those in the other examples cited above, experienced reduced stress and greater ability to meet needs and demands outside of work. For example, merely by coming in a little later and leaving later every day, a father was able to take his son to school. Both the parent and the child were delighted with this opportunity for the parent to regularly participate in his son's school routine.

As demonstrated by these examples, flexibility can be used to enhance organizational performance. For example, managers and employees constantly relate that because the invention engages employees' intelligence, ingenuity, self-interest, team work, sense of fair play and organizational ability, while achieving team-determined goals, it actually changes how work gets done. They also report that concurrently, it changes the people who do the work.

Other embodiments of the invention include applications of these techniques to other fields.

Pilot work has demonstrated that self-respect and self-confidence of the team members increases as a result of being involved with the process. They learn how to make things happen; how to take initiative; solve problems; make and execute complex plans; and achieve desired results. They learn how to get people working together in their common interests. They learn how to lead.

Thus, by its nature, the invention causes the development and enhancement of talent across the organization. By its inclusiveness, it fosters the development of diversity, and diverse leadership in the corporation. Because, to achieve its goals and performance enhancements, it requires constant vigilance to modify its plan as internal and external conditions change, it trains employees to deal successfully, and on an ongoing basis, with inevitable change. By time, talent, and experience, they become able to participate in and advocate for the things that matter most to them.

Since knowledge and understanding of the process impacts employees' interpersonal relationships, they learn to treat themselves, team mates, and supervisors differently, they treat their families differently, and they are better able to relate to their community and its institutions. Just as they have learned to transform their companies' performance, they are able to use their experience, skills, and self-confidence to help transform their families' and community institutions' performance. All of these can be thought of as interdependent. The approach used in the invention recognizes this interdependence, and fosters mutual support between the company, the community, its employees and community institutions, e.g., schools, day care, senior citizen, recreation centers, and health care facilities.

As employees have learned to enhance corporate performance, they transfer their newly gained experience, skills, and self-confidence to enhancing both family and community performance. This is particularly evident as they become engaged in community organizations, accept leadership roles, and assume some responsibility for the organizations' results. This spirit revitalizes family and community effectiveness.

Community and corporate development are symbiotically related. Recognizing this, the invention fosters mutual support between the company, its employees, and their community. By helping create effective volunteers, who can help transform community organizations, companies strengthen their communities and invigorate the corporate/employee-family/community bond. Not only do they benefit from utilizing community resources, they also contribute positively to developing them.

As an example, team-based results-focused techniques can be applied to leverage workplace flexibility to alleviate other concerns such as traffic congestion and pollution. Municipalities can collaborate with corporations to develop strategies for more flexible work arrangements such as variable start and finish times, compressed work weeks, and telecommuting to cut down on the volume of traffic and rush-hour congestion.

In municipalities, employees who have been trained in the techniques identified above can work with their local schools to increase flexibility of school hours for children to be more responsive to the needs of single parent or dual income families. Similar initiatives can be undertaken with health care facilities, senior centers, and the like, to help these social service organizations.

For example, corporations and/or employees can work with municipal organizations, such as Boards of Education and local day care agencies to increase the flexibility of children's school hours and after school programs to be more responsive to the needs of employees' families, including single parent and dual income families. Simultaneously, to help make these extended day programs possible, employees can use their opportunities for flexibility to volunteer in the schools and day care centers their children attend. They can also use their workplace flexibility options to coach school sports, reading, and creative arts enrichment programs, becoming active participants in their children's school lives, while also enabling their local school and day care systems to function more effectively to serve all children's and families' needs. Companies and employees can help support volunteer mobilization efforts for those schools and day care centers that have many employee children in attendance.

Moreover, flexibility options as implemented by the invention enable parents to spend time in their children's schools, fostering relationships and generating the application to apply these techniques to new areas. They also create opportunities for other employees to volunteer in school programs, as well as in senior citizen, service, and health care centers.

Although many of the embodiments described above relate to a corporate environment, the invention can be used in virtually any work setting that uses work teams or groups that collaborate and work together. Other types of business and non-business structures can also utilize the technology of the invention, including non-public, for-profit, charitable, government, and volunteer organizations.

For example, the method can be applied to family health care by hospitals and other care givers at or in connection with school programs, i.e., this service can be applied not only to school children, but also to associated family members. Just as a pilot team can be chosen within a corporation or organization, a pilot agency (functioning as a pilot team) can be chosen within a community. Consider the example of a school which numerous employees' children attend, or a school in a low income community, in which numerous employees would like to volunteer in order to make a difference in their community. Just as a company can view its employees in the totality of their lives, allowing them flexible work options to take care of their personal needs, the pilot school can look at its students in the totality of their lives, not only as students, but also as members of a family. Helping the family solve its problems enables the students to focus on their studies and, in exchange, to get their families' support for applying themselves at school. The school becomes a family center, not only educating children, but also helping their families get the basic support and services they need to function effectively in society.

Enlisting local hospitals to provide family health care on the school site at specified hours; opening the school building to the families in the evening for recreational and educational purposes; having clean used clothing available to families who need it, so no child in the school or family member has to leave home inadequately dressed; helping families find affordable housing, and jobs in local enterprises, creates the most positive bond possible between children, schools, families, and local organizations. Simultaneously, the school staff, supplemented by volunteers from participating companies, enroll, e.g., in the flexible work option process this invention embodies.

This creates the same kind of interpersonal, interagency, community-wide synergy and performance improvement that is created by the invention in corporate settings in which it is applied.

Another example relates to having a group of employees in a company which has rolled out the invention across a large part of the organization, and who now have the opportunity to use their new-found time in productive ways to impact things that affect their lives. They can have a similar concern, such as taking care of aging parents, or getting together to create, volunteer in, and improve the performance of community resources for senior citizens. Using their flexibility options, they can plan and work together to implement performance enhancements for these resources, perhaps also enlisting their company's financial and technical support for their effort.

While the invention has been particularly shown and described with reference to specific preferred embodiments, it should be understood by those skilled in the art that various changes in form and detail can be made therein without departing from the spirit and scope of the invention as defined by the appended claims.

1. A method of using workplace flexibility to increase business productivity of an Employer, comprising the steps of:
a. engaging team members of a working group, with management approval;
b. soliciting input from the working group to improve a particularized team work process;
c. establishing goals in connection with the particularized team work process to be improved;
d. measuring a performance of the improved work process over a predetermined period of time;
e. improving the measured work process performance; and
f. incorporating individualized flexibility arrangements of the team members, memorialized within a formal schedule, on a regular basis into work methods of the work process, thereby enabling achievement of the goals of the particularized team work process.

2. The method of claim 1 further comprising the step of:
g. customizing the implementation based on both the needs of the team members for flexibility and work requirements of the work process.

3. The process of claim 1 wherein the working group is established for purposes of implementing this process.

4. The step of claim 1 further comprising the step of obtaining management approval to implement the process.

5. The process of claim 1 wherein the incorporating step utilizes:
individualized flexible schedules for all of the team members;
goals for improving individual and team performance, to which the team members are committed;
team-member initiated work process changes that enable achievement of the performance and flexibility goals; and
an implementation and review schedule for use in making adjustments as conditions change.

6. The method of claim 1 further comprising the step of:
g. assessing, as a team, performance results and the effectiveness of the individualized flexible arrangements of the team members;
h. using the assessment of flexibility and the work process performance measurement to improve an overall performance of the team members and the particularized team work process.

7. The method of step 6 further comprising repeating steps (b) through (h) on a regular or predetermined basis to enhance efficiency and productivity.

8. The method of claim 1 further comprising the step of:
using a consonance of interests of the team members to help the team members meet their flexibility objectives while simultaneously improving work process performance.

9. The method of claim 1 wherein the individualized flexibility arrangements are used to enable employees to gain greater control over their lives at both work and home.

10. The method of claim 1 wherein the individualized flexibility arrangements result in enhancement of individual team member satisfaction.

11. The method of claim 1 wherein the individualized flexibility arrangements result in individual team member engagement for purposes of attracting and retaining employees and reducing absenteeism.

12. The method of claim 1 wherein step (f) further comprises:
using the individualized flexibility arrangements of the team members to change the nature of relationships between the team members to enhance one or more of collaboration, cooperation, mutual support, and job redundancy, thereby enriching a value of the team members to the organization and to each other.

13. The method of claim 1 wherein absenteeism is reduced and team member retention is increased by the incorporation of the individualized flexibility arrangements.

14. The method of claim 12 wherein the change in the nature of relationships between the team members facilitates mediation of conflicts within the workgroup on a periodic basis.

15. The method of step 1 further comprising the step of:
applying the process to an increased number of working groups.

16. The process of step 1 further comprising the step of:
training facilitators to implement the process on an enterprise-wide scale.

17. The process of step 1 further comprising the step of:
establishing a program management office to oversee a strategy for an enterprise-wide scale up of workplace flexibility, including one or more of:
identifying and training facilitators,
tracking an impact of the method on performance, retention, absenteeism, employee satisfaction, and
communicating results of the method.

18. A method of using workplace flexibility to increase business productivity, comprising the steps of:
a. engaging team members of a working group, with management approval;
b. soliciting input from the working group to improve a particularized team work process;
c. establishing goals in connection with the particularized team work process to be improved;
d. measuring a performance of the improved work process over a predetermined period of time;
e. improving the measured work process performance; and
f. a scheduling means that incorporates individualized flexibility arrangements of the team members into a formal schedule on a regular basis thereby enabling achievement of the goals of the particularized team work process.

19. The method of claim 18, wherein the incorporating step utilizes:
individualized flexible schedules for all of the team members;
goals for improving individual and team performance, to which the team members are committed;
team-member initiated work process changes that enable achievement of the performance and flexibility goals; and
an implementation and review schedule for use in making adjustments as conditions change.
